(19) United States
(12) Patent Application Publication
(10) Pub. No.: US 2015/0256991 A1
(43) Pub. Date: Sep. 10, 2015

(54) SYSTEMS AND METHODS TO DISCOVER ACCESS POINTS (AP) IN WIRELESS NETWORKS

(71) Applicant: QUALCOMM Incorporated, San Diego, CA (US)

(72) Inventors: Alexander Gantman, Yokneam (IL); Vladimir Kondratiev, Haifa (IL)

(73) Assignee: QUALCOMM Incorporated, San Diego, CA (US)

(21) Appl. No.: 14/197,875

(22) Filed: Mar. 5, 2014

(51) Int. Cl. H04W 8/00; H04W 52/02

(52) U.S. Cl. CPC H04W 8/005; H04W 52/0206

(57) ABSTRACT

Systems and methods to discover access points in wireless networks are disclosed. In one embodiment, an access point of a wireless network may be placed in a sleep mode when there is no network activity. Normally, a remote device would not be able to discover such sleeping access points because the access point is not sending out a beacon signal. Exemplary embodiments of the present disclosure provide for a remote device that may send a wake up signal to the access point. On receipt of the wake up signal from the remote device, the access point begins sending a beam formed beacon signal to the remote device to initiate registration of the remote device with the access point. By providing a way to wake a sleeping access point, wireless networks may be effectively established while concurrently saving power and reducing electromagnetic interference.

### BACKGROUND

I. Field of the Disclosure

The technology of the disclosure relates generally to communications between a remote device and an access point.

II. Background

Wireless networks with relatively small footprints are becoming increasingly common as wireless network standards proliferate. For example, many homes now have a WiFi® network that operates on one of the Institute of Electrical and Electronics Engineers (IEEE) 802.11 standards. Likewise, BLUETOOTH® networks allow short range wireless networks such as between a smart phone or audio player and a headset.

The Wireless Gigabit Alliance (WiGig) was a trade association that developed and promoted adoption of a multi-gigabit speed wireless communication technology operating at around 60 GHz and particularly to promote IEEE 802.11 ad. WiGig was subsumed by the WiFi Alliance in March of 2013. However, the WiFi Alliance still promotes 60 GHz communications through the WiGig moniker. Such communications are typically short range (e.g., the size of a room) because the frequencies in question rarely propagate through walls.

In conventional WiGig networks, an access point continuously transmits a beacon signal to alert potential client remote devices as to the existence of the access point. While such access points are typically powered through a wall outlet, such continuous transmission consumes unnecessary power adding to electrical bills, and, in situations where the access point is battery operated, such continuous transmission rapidly depletes the batteries. As another concern, such continuous transmission may raise electromagnetic interference (EMI) concerns with other networks and devices.

### SUMMARY OF THE DISCLOSURE

Embodiments disclosed in the detailed description include systems and methods to discover access points (AP) in wireless networks. In exemplary embodiments, an AP of a wireless network may be placed in a sleep mode when there is no network activity. Normally, a remote device (RD) would not be able to discover such sleeping AP because the AP is not sending out a beacon signal. Exemplary embodiments of the present disclosure provide for a RD that may send a wake up signal to the AP. On receipt of the wake up signal from the RD, the AP begins sending a beam formed beacon signal to the RD to initiate registration of the RD with the AP. By providing a way to wake a sleeping AP, wireless networks may be effectively established while concurrently saving power and reducing electromagnetic interference.

In this regard in one embodiment, a communication system is disclosed. The communication system comprises a RD which comprises a RD wireless transceiver operating at approximately 60 GHz; a user interface and a RD control system operatively coupled to the RD wireless transceiver and the user interface and an AP. The AP comprises an AP wireless transceiver operating at approximately 60 GHz and configured communicate with the RD wireless transceiver using a predefined protocol. The AP also comprises an AP control system operatively coupled to the AP wireless transceiver and configured to place the AP into a sleep mode wherein the RD control system is configured to send a wake up signal to the AP through the RD wireless transceiver such that on receipt of the wake up signal the AP begins transmitting a beam formed beacon signal to the RD so as to initiate a registration of the RD with the AP.

In another embodiment, the AP for a wireless communication system is disclosed. The AP comprises an AP wireless transceiver operating at approximately 60 GHz at a predefined protocol and an AP control system operatively coupled to the AP wireless transceiver. The AP wireless transceiver is configured to send an omnidirectional beacon signal to locate potential client devices during normal operation mode and place power consuming elements of the AP into a sleep mode after a period of inactivity. The AP control system is also configured to receive a signal from a potential client device while in the sleep mode; wake up from the sleep mode in response to reception of the signal; and direct a probe with service description to the potential client device.

In another embodiment, a RD for a wireless communication system is disclosed. The RD comprises a RD wireless transceiver operating at approximately 60 GHz at a predefined protocol; a RD user interface and a RD control system operatively coupled to the RD wireless transceiver and the RD user interface. The RD control system is configured to receive an omnidirectional beacon signal from an AP; send a signal to the AP while the AP is in a sleep mode and receive a directional probe from the AP in response to the signal.

In another embodiment, a method of establishing a communication network is disclosed. The method comprises placing power consuming elements of an AP into sleep mode after a period of inactivity; receiving a signal from a potential client RD while in the sleep mode and waking up from the sleep mode in response to reception of the signal. The method also comprises directing a probe with service description to the potential client RD and allowing communication between the AP and the potential client RD at approximately 60 GHz at a predefined protocol.

### BRIEF DESCRIPTION OF THE FIGURES

FIG. 1 is a simplified block diagram of an exemplary access point communicating with a remote device;

FIG. 2 is a simplified flow chart of a conventional process for establishing a wireless link between access point and remote device;

FIG. 3 is a flow chart illustrating an exemplary process through which an access point may be put to sleep;

FIG. 4 is a flow chart of an exemplary embodiment of a process through which the remote device may wake the access point from a sleep mode; and

FIG. 5 is an exemplary embodiment of a signal chart between the remote device and access point as a communication link is established therebetween.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include systems and methods to discover access points (AP) in wireless networks. In exemplary embodiments, an AP of a wireless network may be placed in a sleep mode when there is no network activity. Normally, a remote device (RD) would not be able to discover such sleeping AP because the AP is not sending out a beacon signal. Exemplary embodiments of the present disclosure provide for a RD that may send a wake up signal to the AP. On receipt of the wake up signal from the RD, the AP begins sending a beam formed beacon signal to the RD to initiate registration of the RD with the AP. By providing a way to wake a sleeping AP, wireless networks may be effectively established while concurrently saving power and reducing electromagnetic interference.

While the present disclosure is particularly useful for AP that are battery powered, power savings on AP that are powered from a wall outlet may also justify use of embodiments of the present disclosure. In either event, the RD may be a mobile terminal such as a smart phone or tablet device.

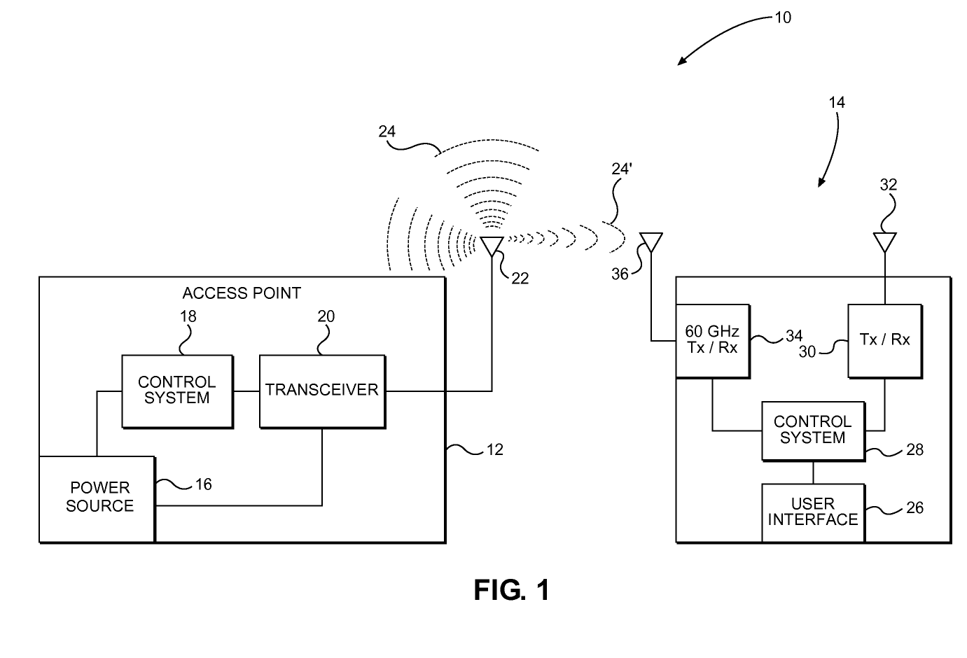

In this regard, FIG. 1 is block diagram of a communication network 10 according to an exemplary embodiment of the present disclosure. The communication network 10 may include an access point 12 communicating with a remote device 14 through a predefined protocol at approximately 60 GHz. In an exemplary embodiment, the predefined protocol is a WiGig protocol or the 802.11 ad protocol. The access point 12 may include a power source 16 that provides power to a control system 18 and a wireless transceiver 20. The wireless transceiver 20 operates according to the predefined protocol using antenna 22 to transmit omnidirectional signals 24 as well as beam formed signals 24′. The control system 18 may include a station management entity (SME) (not illustrated) or communicate with one as is well understood. The power source 16 may be a battery in an exemplary embodiment. Alternatively, power may be supplied to the power source 16 through a wall outlet with appropriate transformers and conditioners.

With continued reference to FIG. 1, the remote device 14 may be a mobile terminal such as a smart phone, tablet, laptop computer, or the like. The remote device 14 may include a user interface 26, which may include a keyboard, display, touchscreen, speakers, microphone, and/or similar non-transitory hardware-based input and output elements. The remote device 14 may further include a control system 28 operatively coupled to the user interface 26. The control system 28 may further be operatively coupled to a cellular wireless transceiver 30 that operates according to a cellular protocol (e.g., Advanced Mobile Phone System (AMPS), Digital AMPS (D-AMPS), Global System for Mobile Communications (GSM), Long Term Evolution (LTE), Code Division Multiple Access (CDMA), Wide Band CDMA (WCDMA), or the like) in conjunction with an antenna 32. The control system may further be operatively coupled to a remote device wireless transceiver 34 configured to operate at approximately 60 GHz through antenna 36. Note that in some remote devices antenna 36 may be the same as antenna 32 (e.g., through a bowtie-meander antenna or other dual mode antenna).

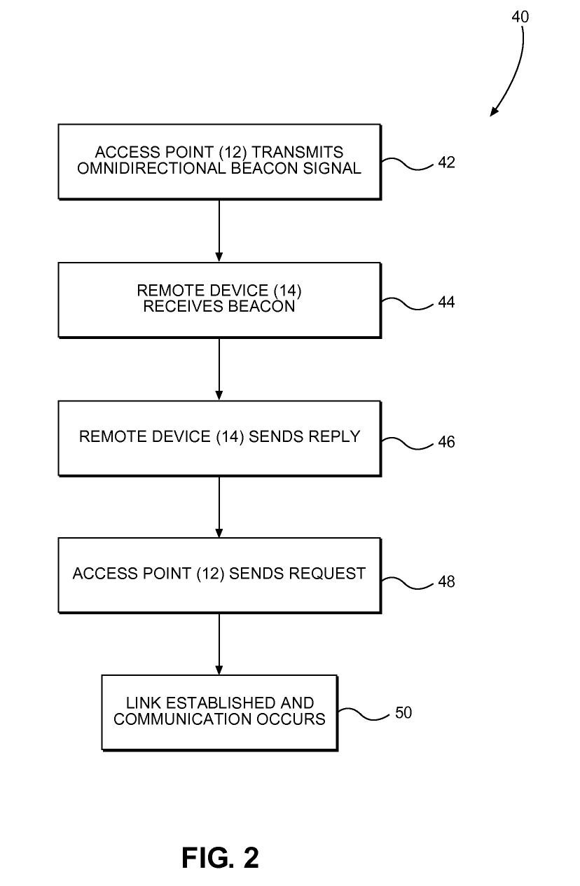

In normal operation, the access point 12 advertises its presence to remote devices such as remote device 14 through an omnidirectional beacon signal 24. A protocol dictated exchange establishes a communication link and communication is then conducted over beam formed signals 24′. In this regard, FIG. 2 illustrates an exemplary flow chart showing a conventional process 40 through which the communication network 10 is established. The process 40 begins with the access point 12 transmitting an omnidirectional beacon signal 24 (block 42). The remote device 14 receives the beacon (block 44). The remote device 14 sends a reply indicating that the remote device 14 is within range of the access point 12 (block 46). The access point 12 then sends a probe request (block 48) with a service description describing available capabilities (e.g., WiGig Bus Extension (WBE) capable, SoftAP, P2P GO, or the like). The probe request may be through a beam formed signal 24′. A communication link is established and communication occurs (block 50). In an alternate embodiment, the reply of the remote device 14 (block 46) is a probe request to which the access point 12 responds to establish a link for communication.

As noted above, in normal operation, the access point 12 may continuously transmit omnidirectional beacon signals 24 as the access point 12 broadcasts its availability to form communication network 10. When the power source 16 is from a wall outlet, such power consumption may add to the electrical bill of the premises. When the power source 16 is a battery, such continuous broadcasting may rapidly deplete the battery, necessitating recharging or rendering the access point 12 inoperative. Accordingly, a first embodiment of the present disclosure contemplates that the access point 12 may be put into an idle or sleep mode.

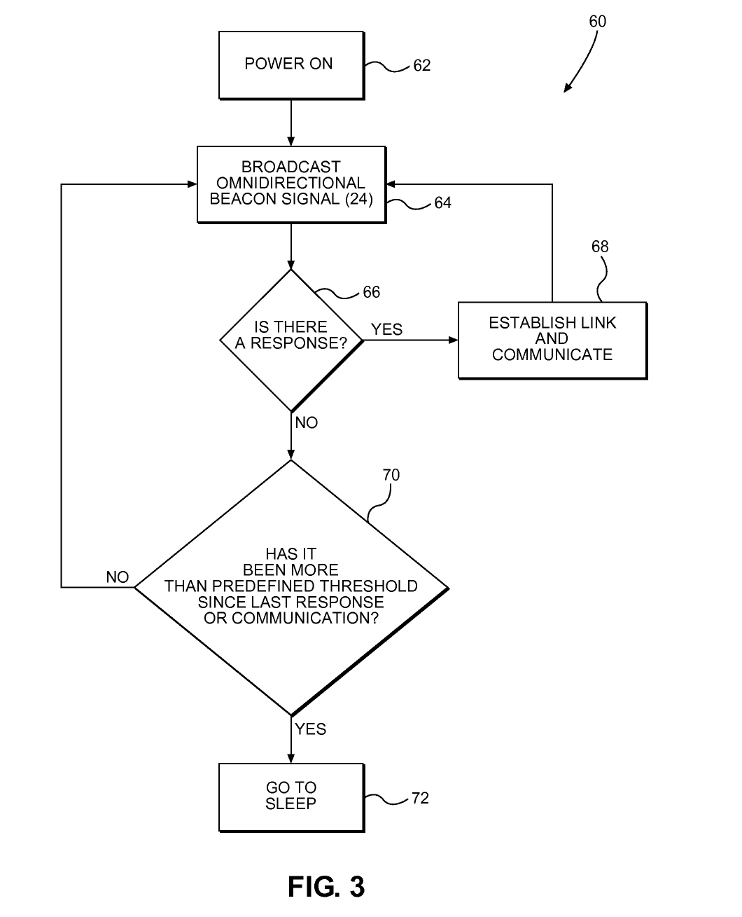

In this regard, the present disclosure provides a technique to save power by placing the access point 12 into a sleep or idle mode. FIG. 3 illustrates a process 60 by which the access point 12 may be put into a sleep or idle mode. The process 60 begins with the access point 12 being powered on (block 62). The access point 12 broadcasts the omnidirectional beacon signal 24 (block 64). The control system 18 determines if there is a response (block 66). If there is a response, then access point 12 establishes a link and communication occurs (block 68, see also block 50 of FIG. 2). If, however, no response is received at block 66, then the control system 18 determines if more than a predefined threshold of time has elapsed since the last response or last communication occurred (block 70). If the threshold has not been exceeded, the process repeats with the continuous broadcast of the omnidirectional signal 24 (block 64). If, however, the threshold has been exceeded, the control system 18 is placed into a sleep or idle mode (block 72). As is well understood, in a sleep or idle mode, most processing functions within the control system 18 and the transceiver 20 are disabled and power is not consumed by such disabled elements.

While putting the access point 12 into a sleep or idle mode helps save power and may reduce EMI, merely putting the access point 12 into a sleep or idle mode is an incomplete solution. Specifically, there needs to be a way to wake the access point 12 when a remote device 14 is within communication range. Embodiments of the present disclosure provide a solution for this need as well. In an exemplary embodiment, the access point 12 continues to listen for incoming communications without transmitting the omnidirectional beacon signal 24. Remote device 14 is programmed to send a wake up signal to the access point 12 which will be heard by the listening access point 12. After receipt of the wake up signal, the access point 12 will wake up and begin normal operation.

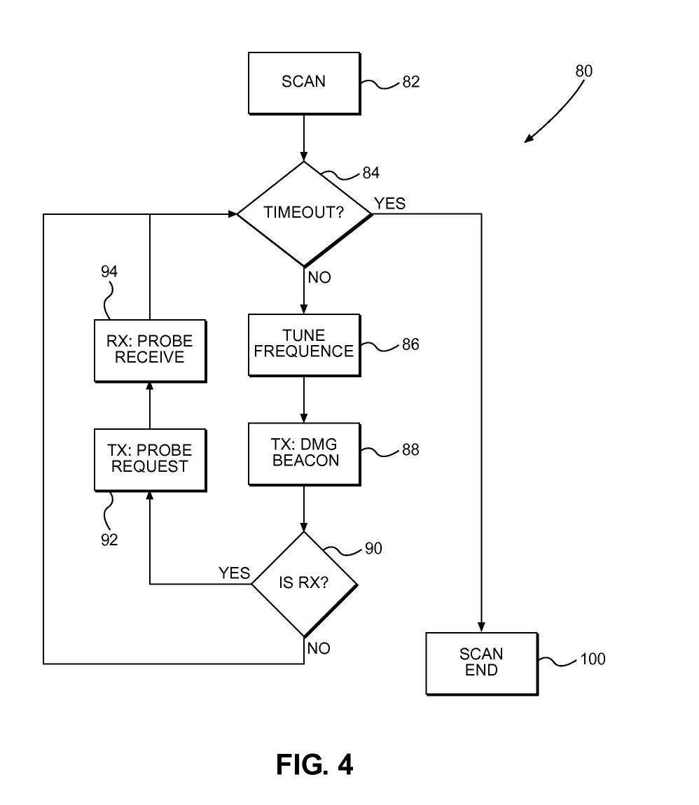

In this regard, FIG. 4 illustrates an exemplary process 80 by which the remote device 14 may wake up the sleeping access point 12. The process 80 begins with the remote device 14 scanning for an omnidirectional beacon signal 24 from the access point 12 (block 82). The control system 28 determines if a timeout has occurred (block 84). If the answer to block 84 is no, a timeout has not occurred, the control system 28 tunes the wireless transceiver 34 (block 86) and transmits a wake up signal (block 88). In an exemplary embodiment, the wake up signal is initiated by a user of the remote device 14 such as by entering a command to connect through the user interface 26. Alternatively, the remote device 14 may periodically send wake up signals to find out if there are proximate access points 12. However, such periodic signaling may drain a battery associated with the remote device 14. In an exemplary embodiment, the wake up signal is a direct multi gigahertz (DMG) beacon as defined under IEEE 802.11 ad. If there is a listening access point 12 within range, the control system 18 of the access point 12 will determine if the DMG beacon has been received (block 90). If the answer is no, the DMG beacon was not received by an access point 12, then the process returns to block 84. If, however, the answer to block 90 is yes, an access point 12 has received the DMG beacon, then the access point 12 wakes and initiates a probe request (block 92) which may be in the form of an omnidirectional signal 24 or a beam formed signal 24′. The remote device 14 receives the probe request (block 94) and communication may begin as previously indicated. Returning to block 84, if there is a timeout, then the scan may end (block 100).

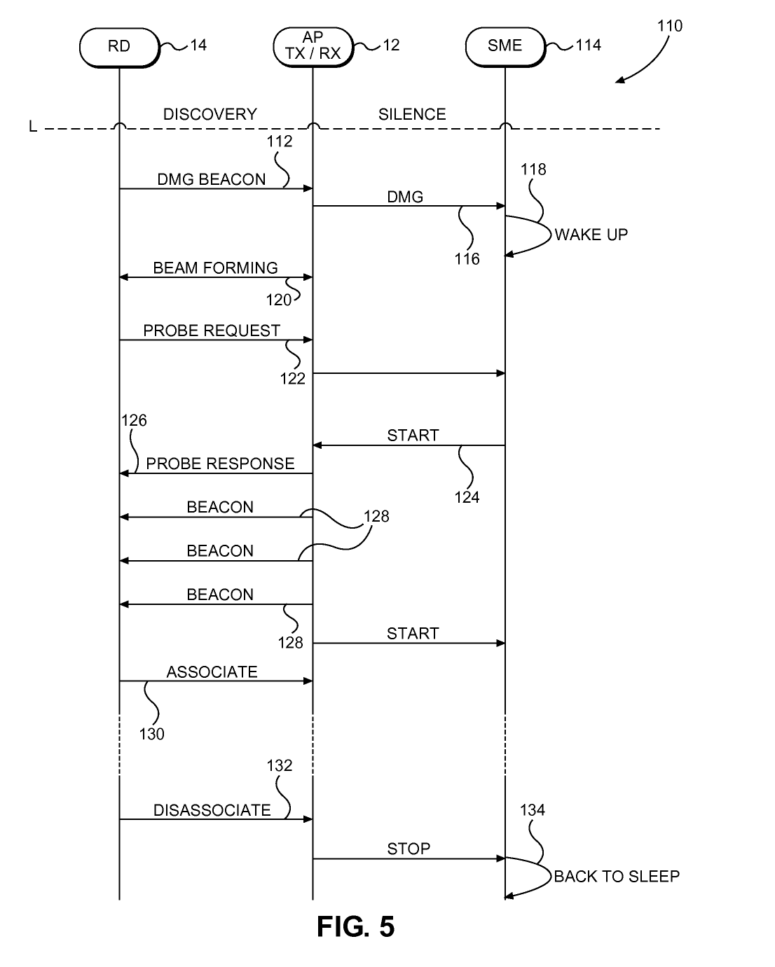

By way of further example, FIG. 5 provides a series of signals 110 that may be exchanged in the process 80. The series of signals 110 begins with the understanding that the access point 12 is in a sleep mode and thus there is no transmission from the access point 12 in the beginning (e.g., “Silence”). The series of signals 110 more practically begins at point L, with the discovery phase. The remote device 14 sends a DMG beacon (signal 112) to the access point 12. The access point 12 passes the DMG signal to the station management entity (SME) 114 (signal 116), which initiates a wake up of the access point 12 (signal 118). Now the access point 12 is awake, and capable of performing beam forming (signal 120). Note that the remote device 14 may resend the DMG beacon (signal 112) until it receives a beam forming frame (signal 120).

With continued reference to FIG. 5, once the remote device 14 has received a beam forming frame (signal 120), the remote device 14 may initiate a probe request to the awake access point 12 (signal 122), which is also shared with the SME 114. If the probe request (signal 122) is sent before the access point 12 is fully awake, the access point 12 does not respond, and the remote device 14 may resend the probe request (e.g., periodically) as part of the normal discovery techniques within the protocol. The SME 114 provides a start signal 124 to the access point 12. The access point 12 then provides a probe response signal 126. The access point 12 is now awake and may generate multiple omnidirectional beacon signals 128 which allows the remote device 14 to associate (signal 130) with the access point 12 until such time as the pair disassociate (signal 132), after which, the access point 12 returns to sleep.

While an optimal design will allow sufficient time to wake the access point 12 at signal 118, it is possible that the access point 12 may receive multiple DMG beacons (signal 112) from multiple remote devices 14 before finishing waking. In such an instance, the access point 12 may send multiple beam forming frames (signal 120). Current conventional rules within the WiGig protocol accommodate receipt of such plural beam forming frames.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A communication system comprising:
a remote device (RD) comprising:
a RD wireless transceiver operating at approximately 60 GHz;
a user interface; and
a RD control system operatively coupled to the RD wireless transceiver and the user interface; and
an access point (AP) comprising:
an AP wireless transceiver operating at approximately 60 GHz and configured to communicate with the RD wireless transceiver using a predefined protocol;
an AP control system operatively coupled to the AP wireless transceiver and configured to place the AP into a sleep mode;
wherein the RD control system is configured to send a wake up signal to the AP through the RD wireless transceiver such that on receipt of the wake up signal the AP begins transmitting a beam formed beacon signal to the RD so as to initiate a registration of the RD with the AP.

2. The system of claim 1 wherein the RD wireless transceiver operates according to an Institute of Electrical and Electronics Engineers (IEEE) 802.11 ad standard.

3. The system of claim 1 wherein the AP comprises a power source.

4. The system of claim 3 wherein the power source is a battery.

5. The system of claim 1 wherein the AP control system is configured to cause the AP wireless transceiver to send omnidirectional beacon signals for a period of time after receipt of the wake up signal.

6. The system of claim 1 wherein the RD is configured to use the AP after the registration of the RD with the AP.

7. An access point (AP) for a wireless communication system, the AP comprising:
an AP wireless transceiver operating at approximately 60 GHz at a predefined protocol; and
an AP control system operatively coupled to the AP wireless transceiver and configured to:
send an omnidirectional beacon signal to locate potential client devices during a normal operation mode;
place power consuming elements of the AP into a sleep mode after a period of inactivity;
receive a signal from a potential client device while in the sleep mode;
wake up from the sleep mode in response to reception of the signal; and
direct a probe with service description to the potential client.

8. The AP of claim 7, wherein the AP wireless transceiver operates according to an Institute of Electrical and Electronics Engineers (IEEE) 802.11 ad standard.

9. The AP of claim 7, further comprising a power source.

10. The AP of claim 9, wherein the power source is a battery.

11. The AP of claim 7, wherein the AP control system is configured to cause the AP wireless transceiver to send omnidirectional beacon signals in the normal operation mode for a period of time after receipt of the wake up signal.

12. A remote device (RD) for a wireless communication system, the RD comprising:
a RD wireless transceiver operating at approximately 60 GHz at a predefined protocol;
a RD user interface; and
a RD control system operatively coupled to the RD wireless transceiver and the RD user interface, the RD control system configured to:
receive an omnidirectional beacon signal from an access point (AP);
send a signal to the AP while the AP is in a sleep mode; and
receive a directional probe from the AP in response to the signal.

13. The RD of claim 12, wherein the RD comprises a mobile terminal.

14. The RD of claim 13, wherein the mobile terminal comprises a smart phone.

15. The RD of claim 12, wherein the RD wireless transceiver is configured to operate according to Institute of Electrical and Electronics Engineers (IEEE) 802.11 ad standard.

16. The RD of claim 12, wherein the RD control system is configured to effectuate registration of the RD with the AP after receipt of the directional probe.

17. The RD of claim 12, wherein the signal comprises a DMG signal.

18. The RD of claim 12, wherein the RD control system is configured to send the signal in response to user input received through the user interface.

19. The RD of claim 12, wherein the RD control system is configured to send the signal periodically.

20. A method of establishing a communication network, the method comprising:
placing power consuming elements of an access point (AP) into a sleep mode after a period of inactivity;
receiving a signal from a potential client remote device (RD) while in the sleep mode;
waking up from the sleep mode in response to reception of the signal;
directing a probe with service description to the potential client RD; and
allowing communication between the AP and the potential client RD at approximately 60 GHz at a predefined protocol.

21. The method of claim 20, wherein the predefined protocol comprises an Institute of Electrical and Electronics Engineers (IEEE) 802.11 ad protocol.

22. The method of claim 20, further comprising generating an omnidirectional beacon signal from the AP after waking up from the sleep mode.
